(19) United States
(12) Patent Application Publication
(10) Pub. No.: US 2015/0149237 A1
(43) Pub. Date: May 28, 2015

(54) Systems and methods to improve sales effectiveness utilizing a moving, contextually relevant navigator to guide sales representatives in prospect communications based on prospect's digital and conversational behavior and organization's best sales practices

(71) Applicant: Richard Thomas Brock, Scottsdale, AZ (US)

(72) Inventor: Richard Thomas Brock, Scottsdale, AZ (US)

(21) Appl. No.: 14/549,490

(22) Filed: Nov. 20, 2014

Related U.S. Application Data
(63) Continuation of application No. 61/907,542, filed on Nov. 22, 2013.

(51) Int. Cl. G06Q 10/06; G06F 17/30; G06Q 10/10

(52) U.S. Cl. CPC G06Q 10/0633; G06Q 10/06398; G06Q 10/107; G06F 17/30321; G06F 17/30424
USPC 705/7.27

(57) ABSTRACT

Systems and methods to optimize sales performance operating in the manner a sales rep works: capturing prospect interactions real-time, providing a navigation tool and talking points to facilitate timely and relevant communications, and automatically updating Customer Relationship Management (CRM) and other systems—enabling users to effectively execute sales strategies. Prospect interactions are time-stamped and tracked to create a story-so-far record for each prospect. A customized, key-word searchable database of talking points provides intelligent, consistent knowledge to the user during prospect communications. Unlimited, unique moving navigators categorize talking points according to the organization's database of information and are customized to optimize data retrieval. Drag-and-drop emails are created by selecting pre-defined, best practice talking points or can be personalized in one-to-one campaigns, and include automated embedded tracking of prospect's email opens and clicks. All activities are timed and tracked from beginning to close of sale providing sales process analyses.

### CROSS-REFERENCE TO RELATED APPLICATIONS

Provisional Patent Application Ser. No. 61907542 EFS#17479056/Confirmation #1347/Date: 22 Nov. 2013

### FEDERALLY SPONSORED RESEARCH

Not Applicable

### SEQUENCE LISTING

Not Applicable

### BACKGROUND OF THE INVENTION

The present invention is in the technical field of a sales automation system. More particularly, the present invention is in the technical field of systems and methods for gathering and providing real-time textual and graphical representations of prospect digital and conversational behaviors and using a moving, contextually relevant navigator to guide a sales representative (sales rep) in timely and relevant communications with a prospect to facilitate and accelerate sales.

The modern sales call—sales in general—is challenging. Sales reps are engaging in sales activities and communications from the office, from home, on the road, from any location they may be when contacting a prospect. The internet has facilitated a buyer's access to a significant amount of product or service information. Today's business-to-business (B2B) buyers will have gone through 67% or more of the traditional buying cycle before even speaking to a vendor. When they do, that buyer will be far more educated and independent in their decision-making than in the past. The sales rep who communicates with that buyer must be able to converse effectively—must have all the product information, marketing material and talking points at their fingertips, must have all their competitors' information available—in order to ensure that the first and subsequent interactions with the prospect address that prospect's unique needs, inquiries and sales objections. If the sales rep is unable to communicate the seller's value proposition effectively, that sales rep will not be able to close the sale.

Some common scenarios include: a sales rep is given a lead for follow-up, with a few buying signs outlined and is expected to close a deal; a sales rep has had a full day of sales calls and at the end of the day (or trip) needs to—update the company's Customer Relationship Management (CRM) system with notes taken during the calls, initiate follow-up activities (e.g., send emails with information requested or messages to reinforce key points of their conversations), find price sheets, identify references, locate product specifications, and send everything to the right prospect. Sales reps know they should update their CRM system to record the information discussed with each prospect, but it may be after hours, very late, or their ability to perform the CRM update delayed. The inevitable result is that if the sales rep updates the CRM system, only short notes are entered that they hope will prompt them to think of the points that should be followed up on the next time they call on, or hear from, this particular prospect. Meanwhile, the detail information that sales managers would like to see to better understand the sales pipeline is generally not entered and, therefore, not available leaving managers guessing as to pipeline status or efficiency of their sales processes.

The invention eliminates the fears and burdens that are universally experienced by new and experienced sales reps. With just a few clicks, using the invention will provide relevant, targeted talking points that will prompt the sales rep to ask appropriate questions to ascertain the prospect's needs and answer specific inquiries; enable the sales rep to record a note on the topics discussed with prospects, update the sales stages, tag the deals for the forecast, prepare emails—the sales rep is able to just choose the best “go-to” email as a follow-up to the call—drag-and-drop the content from the talking points repository of marketing and technical information, and make a few edits to the email to personalize each message to the prospect. The sales rep's activities are automatically captured by the system, timed, and added to the prospect's timeline or “story-so-far”, eliminating the manual entries previously required to update CRM systems and other sales databases.

Getting sales reps to use—or even update—a company's CRM system is one of the biggest challenges for management. A key feature of the invention is its ability to automatically synchronize prospect data with a company's CRM system. The invention is unique because it delivers more critical data than earlier systems by tracking the timing and flow of every interaction with a prospect—each and every digital and conversational behavior is logged into the story-so-far, complete with the time spent on each conversational event. During a call, the system tracks and logs the talking points—at each stage of the cycle—as well as the order of the conversation. The reporting function displays dashboards showing the sales processes of each sales rep. Sales managers are able to see at a glance and determine which sales reps' processes are resulting in higher sales, enabling managers to develop a blueprint that can be replicated with under-performing sales reps.

Fast forward. Your sales rep has just completed a successful call using the tool. Now it's time to reinforce those talking points in a high-impact, follow-up email. By using the email-messaging feature within the invention, sales reps are one click away from delivering timely, relevant messages. All it takes is the one-time creation of an easily accessible library of contextual content, links to white papers or landing pages, or other information that will help close the business. By opening a prospect record within this application—which automatically syncs to the CRM system—sales reps can drag-and-drop content blocks to assemble quick and easy, personalized emails that perfectly complement past conversations and advance the sales cycle.

Adding a simple tracking code to the organization's website enables sales reps to receive an alert when a prospect clicks email links, view the prospect's complete digital behavior, and track all future conversational and digital behavior to optimize the sales rep's ability to make future contacts more targeted and meaningful. The invention simplifies a sales rep's call preparation activities by providing discovery data, product information, pricing, competitive intelligence and more—all essential components to ensure a successful sale. The customized talking points are easily and quickly accessible utilizing a “Google-like”, key-word search thereby enabling the sales rep to respond to a prospect's questions rather than following a structured sales play-book that may not be responsive to that prospect's interests. In sharp contrast, this tool makes the entire organization's knowledge repository available to the sales rep, delivering to them what they need to know when they need to know it using the moving, contextually relevant navigator.

Some attempted solutions have provided sales managers with limited, general sales stage activity classifications but have not provided sufficiently detailed information that would arm the sales manager with the information they need to monitor and improve their sales processes. The system's story-so-far contains all interactions between sales rep and prospects, giving them a view of specific activities or time spent on such activities during the sales cycle. Sales managers often know that a particular sales rep is successful in closing more business faster but often do not know and cannot replicate the formula that makes that sales rep successful. With this tool, the tracking and reporting of each prospect's sales cycle, from initial contact to closing, provides sales managers with important information that enables managers to adjust sales processes to mirror those being utilized by the most productive sales reps.

This tool is exceptionally intuitive and the least disruptive sales performance enabler both sales reps and managers will want to use.

### SUMMARY OF THE INVENTION

The present invention is a cloud-based sales execution technology and system that interprets a plurality of sales rep's conversations and actions through a real-time, electronic click or touch and combines that information with a prospect's conversational and digital behavior enabling a sales rep to engage in relevant, consistent and timely communications with a prospect to improve the sales rep's effectiveness in closing sales.

In particular, it is a primary object of the present invention to provide systems and methods that will accelerate sales by enabling a sales rep to communicate more effectively with prospects utilizing customized talking points available to the sales rep by key-word searches or by clicking appropriate topics on the moving, contextually relevant navigator, making new and seasoned sales reps experts in their organization's products and sales processes.

It is also an object of the present invention to provide systems and methods to track the digital and conversational behavior of the prospect that is updated real-time and available to the sales rep and sales managers to view at any time, thereby preparing a sales rep for the next prospect interaction and allowing sales managers to quickly and easily determine each prospect's sales stage.

It is another object of the present invention to provide systems and methods that will allow the sales rep to easily and quickly communicate with a prospect by providing scripted emails, access to the organization's marketing materials, white papers, pricing information, and other relevant materials that the sales rep can send to the prospect with a few key strokes. Email communications and campaigns can be customized and personalized or sales reps can utilize pre-existing email templates and campaigns.

It is also a further object of the present invention to provide systems and methods to track the sales stages of each prospect from initial contact to closing with a graphical representation of the time period associated with each stage enabling sales managers to see the progress of each sales opportunity as it unfolds, and to determine the most effective sales process that will result in closing a sale. Such performance analysis of the sales cycles and time to closing will enable sales managers to improve sales methods across their sales teams to obtain better sales performance.

It is an additional object of the present invention to provide systems and methods to facilitate and enhance the sales rep's usage of existing CRM systems with two-way synchronization and use of touch conversation boxes to easily and automatically update the user organization's CRM system.

It is another object of the present invention to provide a training system that provides online coaching for new sales reps through a moving, contextually relevant navigator that provides access to current product information, marketing information, objection-handling information, other sales information deemed important, and the organization's sales strategies enabling new sales reps to easily navigate and manage the progression of the sales cycle.

The system allows visibility into the sales process, provides context for coaching sales reps, and provides the structure for sales reps to prepare and strategize for the next call. It is within the capabilities of the present invention to provide for simple and easy navigation between the powerful functions enabled on each screen, moving from viewing public information to preparing for the next call using call preparation, and utilizing the appropriate navigator and talking points to access relevant information relating to a specific topic.

The power, flexibility and synchronization of the system allows the user organization to easily and effectively monitor, implement and execute its sales strategies and grow its business through an intuitive and non-disruptive sales performance enabler.

Additional features and advantages of the present invention will become apparent to those skilled in this art from the following description and drawings wherein there is described a preferred embodiment of this invention in one of the best modes contemplated for carrying out the invention. As will be realized, the invention is capable of other different embodiments and its several details are capable of modification in various and obvious aspects, all without departing from the invention. Accordingly, the drawings and descriptions will be regarded as illustrative in nature and not as restrictive.

### BRIEF DESCRIPTION OF THE DRAWINGS

For a further understanding of the objects and advantages of the present invention, reference should be made to the following description, taken in conjunction with the accompanying drawings in which:

FIG. 1 is a representation of the chronological story-so-far of the interactions with a prospect as it relates to the communications, conversations, digital behavior and actions undertaken by the prospect or between the organization and the prospect, according to an embodiment of the present invention;

FIG. 2 is a representation of a screen display summarizing the public information regarding the prospect and the information captured in previous calls that will prepare the sales rep for the next prospect interaction, according to another embodiment of the present invention;

FIG. 3 is a representation of a browser display describing a particular subject that the prospect may raise as an issue to discuss with the sales rep, according to a still further embodiment of the present invention;

FIG. 4 is a representation of an illustrative email template that facilitates the sales rep's ability to create or edit a relevant email communication to the prospect by selecting from prebuilt templates that appear in a pop-up selection box, another embodiment of the present invention;

FIG. 5 is a representation of an illustrative graphical display report, showing detailed information relating to activities undertaken by all the sales reps with their prospects, that enables a sales manager or management to ascertain the extent to which each sales rep is following the prescribed sales processes, according to an embodiment of the present invention;

FIG. 6 is a representation of a tool that the sales rep can utilize to create a personal, one-to-one campaign, according to an embodiment of the present invention;

FIG. 7 is a representation of a screen display that enables a sales rep to easily add or remove a prospect from marketing campaign(s), according to an embodiment of the present invention.

### DETAILED DESCRIPTION OF THE INVENTION

Although specific embodiments of the present invention will be described by referring to drawings, it should be understood that such embodiments are by way of example only and merely illustrative of but a small number of the numerous possible embodiments which can represent applications of the principles of the present invention. Modifications, obvious to one skilled in the art to which the present invention pertains, are deemed to be within the spirit, scope, and contemplation of the present invention, as further defined in the claims.

The present invention is a unique integrated, synchronized software system which receives automatic input from prospect digital behavior, user actions, and system tracking information to create cloud-based, digital records accessible by sales reps and sales managers any time from any device. The information that is collected, stored, easily searchable, displayed and made available to sales reps and sales managers provides intelligent, relevant data and talking points that will accelerate both sales training and the sales cycle. Data analysis enables sales managers to assess effectiveness of sales methods, evaluate individual sales rep's performance, determine sales stages for each prospect—in effect, give managers the tools and information that will help them improve their organization's sales performance.

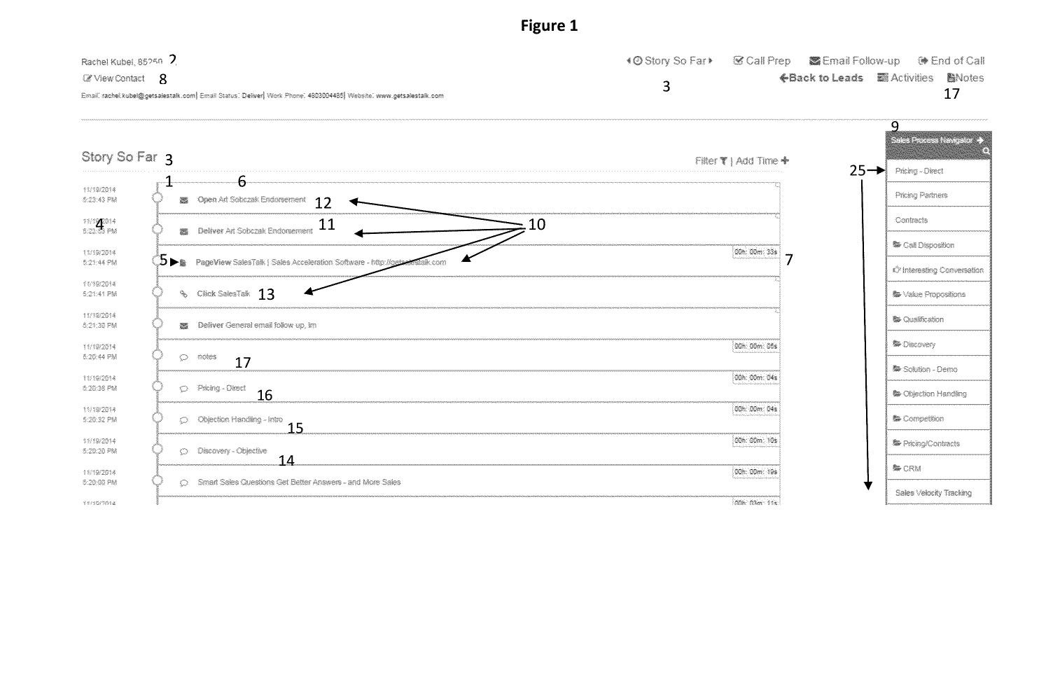

Referring now to the invention in more detail, in FIG. 1 the sales rep can see the timeline (1) of all the digital and conversational behaviors that the organization has had with a specific prospect (2). The “story-so-far”(3) identifies the date and time of the event (4), the type of digital behavior or conversational behavior utilizing an icon (5), and a brief description of each such behavior (6). When appropriate, the behavior will have an elapsed time period (7) associated with it. The “view contact” icon (8) enables a sales rep to view, edit or update any information on the prospect. The moving, contextually relevant “navigator” (9) tool—a key component of the invention—is present on each page of the application. The navigator (9) serves as the gateway to create, edit and display all information that may be relevant to the user organization's prospects.

In more detail, still referring to the invention of FIG. 1, prospects may enter the system from one of several sources, such as: forms filled in on the organization's website; imported from trade show or other event lists; imported from the organization's CRM system; or manual entry by the sales rep. Two-way synchronization with major CRM systems allows prospects (or leads as they are commonly labeled) to be entered or updated in this invention or the user's CRM system, thereby ensuring that both invention and user's CRM systems contain the same common information. The synchronization between systems is a key component for (i) sales reps who avoid the time-consuming task of entering data into multiple systems, and (ii) sales managers or management who want and may need to see specific details concerning a prospect's sale stage or sales process being utilized by the sales rep with respect to a prospect.

In more detail, still referring to the invention of FIG. 1, behaviors (10) are designated as (i) digital behaviors, which include behaviors such as: deliver email (11); opened email (12); clicked-on link within an email (13); or (ii) conversational behaviors, which include behaviors such as: discovery questions (14); objection handling (15); pricing (16); or, sales rep's notes (17). Prospect behaviors are automatically captured, including the date, time and duration of the event, for the purpose of creating each prospect's story-so-far that enables the sale rep and sales manager to see at a glance the behavior of the prospect and the activities of the sales rep throughout the sales cycle. According to the present invention, the story-so-far synopsis provides pertinent, timely information making the sales rep's interactions with the prospect more efficient for both parties, accelerating the sales cycle.

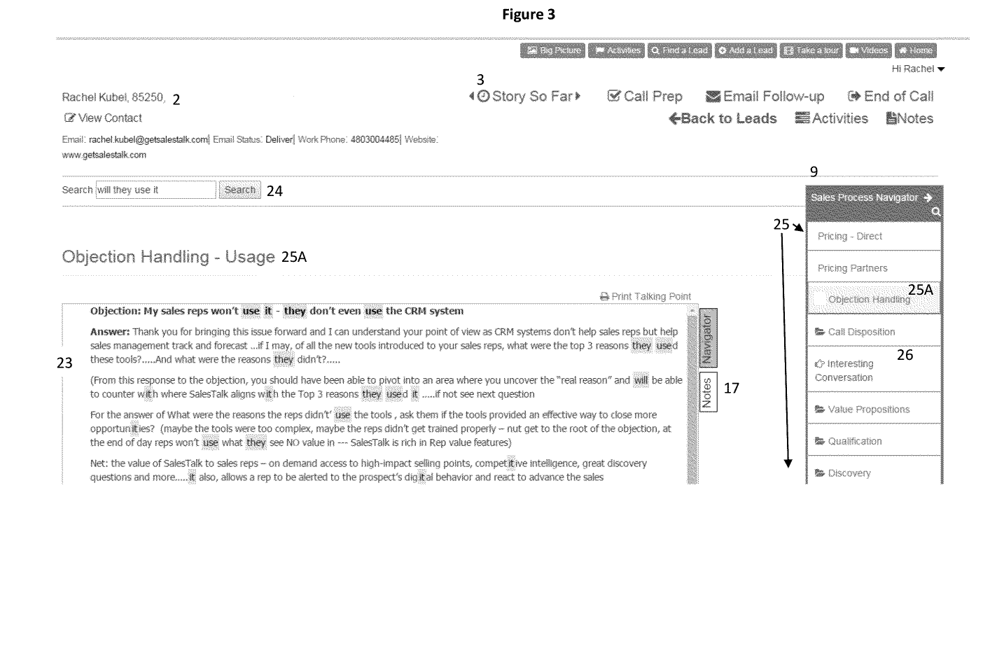

In more detail, still referring to the invention of FIG. 1, the moving, contextually relevant “navigator” (9) is created from the “talking points” (25) (see more detail in FIG. 3) and is customized, without limitation, for specific industries, products, prospect personas, sales territories, languages, or by other areas or topics as needed by the user. Each user organization can have multiple navigators (9) and sales reps can select the appropriate navigator (9) from a sliding pop-up selection box choosing the navigator (9) that is the most effective tool for a particular prospect or contact person based on demographic or other details. According to the present invention, the flexibility of multiple, easily selectable navigators, enables the sales rep to quickly retrieve appropriate and relevant talking points and information.

In further detail, still referring to the invention of FIG. 1, a sales rep views the story-so-far (3) behavior data from anywhere in the application by clicking on the story-so-far (3) button at any time.

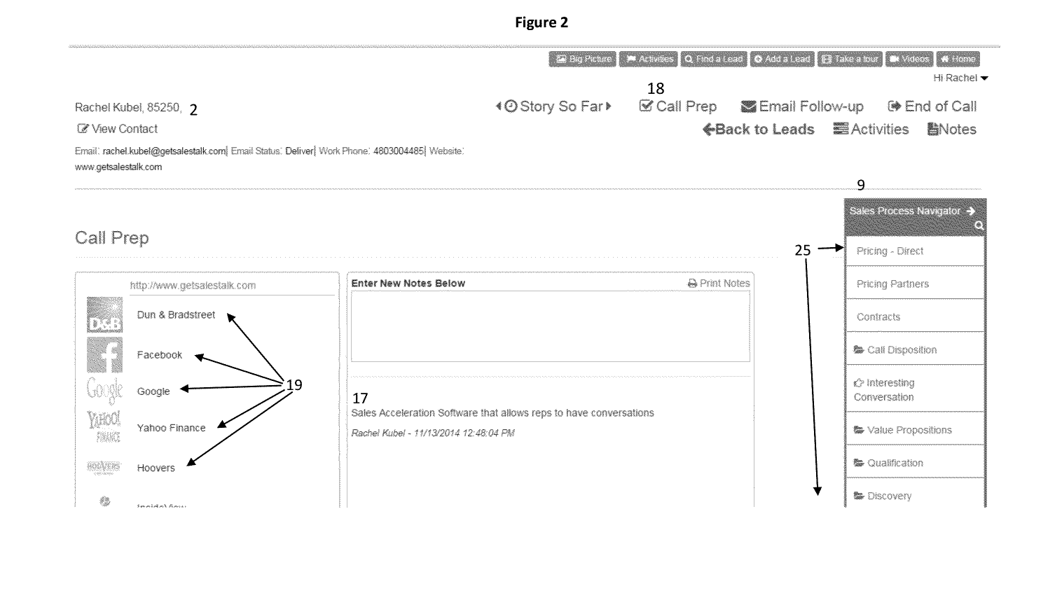

Referring now to the invention in more detail, in FIG. 2 the sales rep clicks on the “call prep” (18) button at any time to view public information (19) about the prospect (2) and all sales rep's notes (17) previously captured in order to prepare for the next communication with the prospect (2). The sales rep utilizes the navigator (9) tool to review any information in the talking points (25) on topics that the sales rep anticipates discussing with the prospect (2).

In more detail, still referring to the invention of FIG. 2, the public information (19) includes data such as: the prospect's website, information captured by commercial information sites; information available through Dun & Bradstreet, Facebook, LinkedIn, and others; information displayed by search engines such as Google. However, while the public information is provided as an example, it is to be understood that other data, both presently known and hereinafter developed, may also be used in conjunction with the present invention to provide additional prospect public information in a manner most beneficial to the invention without departing from the scope of the invention.

Referring now to the invention in more detail, in FIG. 3 the sales rep utilizes the moving, contextually relevant navigator (9) to view in more detail any and all information that has been accumulated about specific talking points, such as objection handling (25A). According to the present invention, the talking points, product details, pricing data, competitor information can be copied and pasted from the user's own web site or other sources and can be customized to the look and feel of the user's own web site.

In more detail, still referring to the invention of FIG. 3, the selection of a particular talking point (25A) in the navigator or a search by key-word (24) initiates a timer that tracks the time spent discussing that particular talking point (25A) with the prospect (2), according to a further embodiment of the present invention. The invention automatically logs this talking point (25A) and the time spent into the story-so-far (3), updates the user's CRM system with the time spent on each talking point (25), and adds this information to the reports table making it available for subsequent analysis by management. The automatic, real-time gathering and storing of this data in the invention's system and touch-of-a-button or automatic synchronization with the user's CRM system is unique as all the details of the talking points is made available to such CRM system. While the present invention is described with respect to its application with user CRM systems such as SalesForce, it is to be understood that the invention may be utilized in other customer relationship management applications, both now known and hereinafter developed, without departing from the scope of the invention.

0031 In more detail, still referring to the invention of FIG. 3, the talking points (25) display the content that will support the sales rep's conversation with the prospect (2), thereby providing accurate and consistent information building greater trust in the sales rep with the prospect. Talking point creation is unlimited in amount of detail and organization and is customizable on a user-by-user basis.

In more detail, still referring to the invention of FIG. 3, the default navigator (9) displays a scrollable window of information designed for sales rep's unique conversation with the prospect (2) with the option of toggling among several windows of information—including information that can be automatically inserted into an email addressing the particular talking points (25) a prospect had raised. Navigators are customizable by users and a user can have any number of navigators that best allows a sales rep to navigate through the company's product information, sales scripts and other selling aids.

In more detail, still referring to the invention of FIG. 3, the search box (24) field depicted at the top of talking point (25A) allows a sales rep to search the user organization's materials (content repository) to bring up a list of talking points (23) in the current navigator (9) that may address a particular topic, or to search the entire database of talking points to find information on any sales, marketing, competitor, technical or other information that is not in the navigator (9) currently displayed. According to the embodiment of the present invention, all of the user organization's materials are accessible and will be displayed to the sales rep instantly, enabling the rep to address the particular subject raised by the prospect.

In more detail, still referring to the invention of FIG. 3, the sales rep is able to take notes (17) while discussing talking points (25) with the prospect (2). These sales rep notes (17) are automatically added to the story-so-far (3) and will also be tagged as related to the specific talking point (25A) for subsequent reporting. Clicknotes (26) are accessible from the navigator (9) and are used for entering information directly into the story-so-far (3) and automatically updating the user's CRM. Clicknotes are also processed by the system's rules engine to trigger new sales actions.

In further detail, still referring to the invention of FIG. 3, the talking points (25) content is drawn from an unlimited database of information sources related to the subject of the talking points (25). The sales rep can choose different contextual information, for example, as depicted in FIG. 3, conversations (what to say), sample email copy, bulleted points of relevant information, and any other sales aids developed for the purpose of guiding the sales rep during the conversation with the prospect (2) or to be copied into a PowerPoint presentation or shared with the prospect (2) in any format. The drop-down navigator (9) list can be utilized to identify pertinent information, such as, pricing, value propositions, and other information that can be subsequently communicated to the prospect (2).

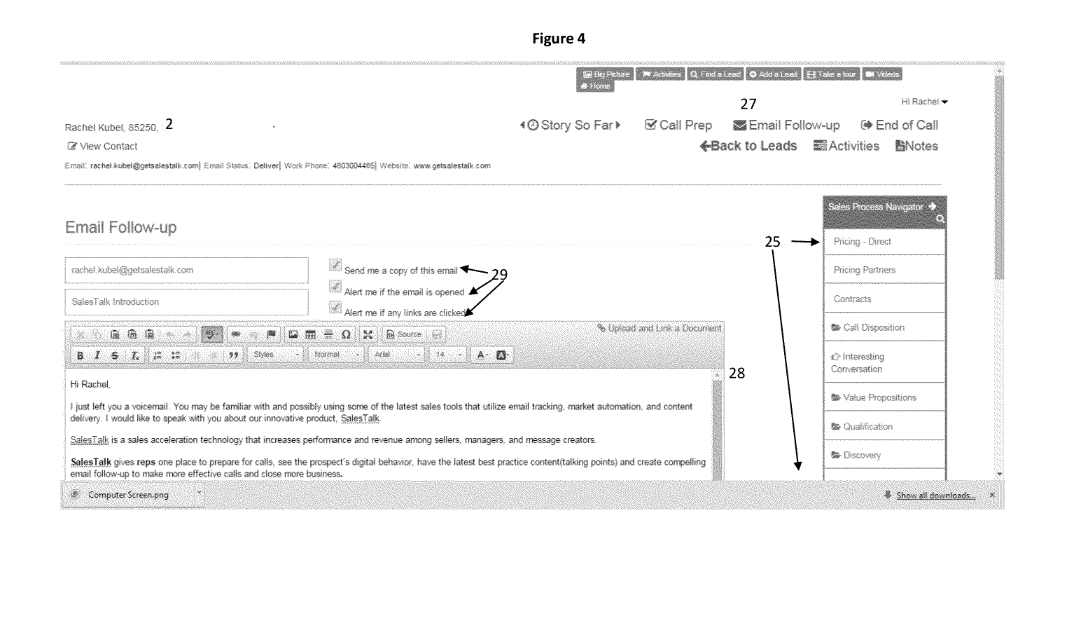

Referring now to the invention in more detail, in FIG. 4 the sales rep easily views and chooses a follow-up email template from a scrollable pop-up selection box by clicking the “Email Follow-Up” (27) button on any screen in the invention. Clicking on any talking point (25) while in this follow-up (27) mode enables the sales rep to drag-and-drop any content from the talking point (25) into the email text or copy-and-paste any information from any other talking points.

In more detail, still referring to the invention of FIG. 4, the invention sends the email (28) created to the prospect (2) and automatically tracks email delivery, opens and clicks.

In more detail, still referring to the invention of FIG. 4, the tracking codes in the email (28) alert the sales rep when the email is opened (29), when links within the email are clicked (29), and collects other data that may be pertinent.

In further detail, still referring to the invention of FIG. 4, a copy of the email is automatically sent (29) to the sales rep and a copy of the email (28) is added to the story-so-far database to provide a complete picture of the digital and conversational behavior of the prospect (2) enabling the sales rep and sales manager to better assess that prospect's sales path.

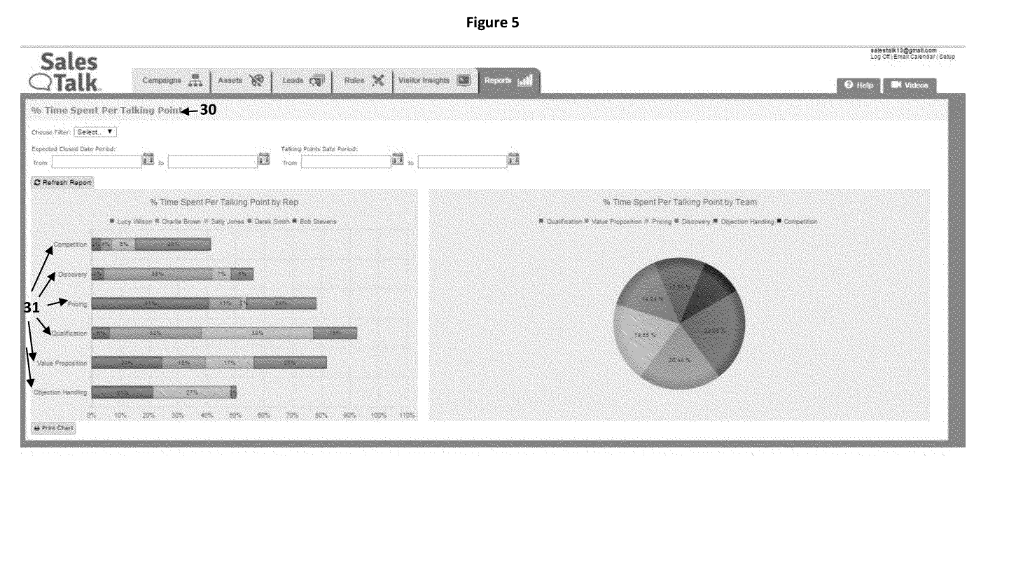

Referring now to the invention in more detail, in FIG. 5, the sales rep and sales manager have the ability to view a variety of reports, a sample of which is depicted in this drawing. The “Time Spent Per Talking Point” report (30) shows the sales rep's time in conversations with prospects allocated amongst the various talking point topics (31).

In more detail, still referring to the invention of FIG. 5 (sample report), the invention includes many reports that show the time spent in each of the various digital or conversational behaviors, providing unique and useful information to management to assess the optimum sales process to close more business faster. This information and insight empowers management to identify best sales practices and tailor internal sales processes to obtain better sales performance from the sales reps.

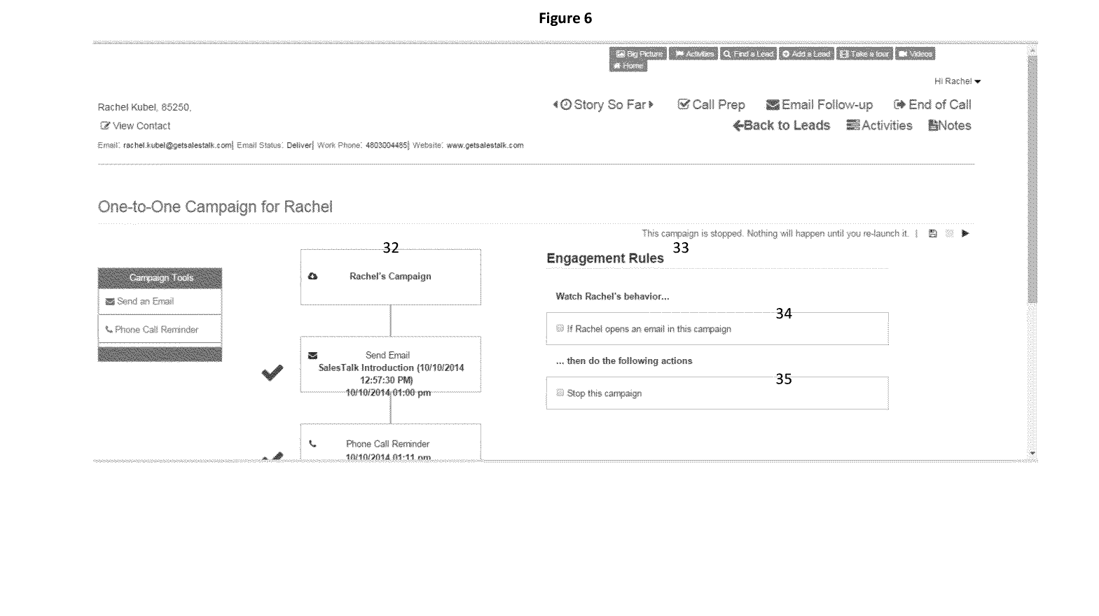

Referring now to the invention in more detail, in FIG. 6 (One-to-One Campaign), the invention allows a sales rep to use a drag-and-drop feature to create a personalized workflow diagram that defines and executes a sales process for a particular prospect based on information collected by the sales rep to date.

In more detail, still referring to the invention of FIG. 6, the drag-and-drop feature enables the sales rep to create the workflow (32) that (i) visually depicts and schedules the immediate sending of emails, (ii) schedules future sending of emails on specified dates and times, and (iii) schedules future phone call reminders, tasks, and appointments. Engagement rules (33) can be selected to observe a prospect's digital behavior (34) to trigger certain automatic actions—for example, stopping a campaign (35) or alerting the sales rep that a prospect has opened an email or clicked on a link.

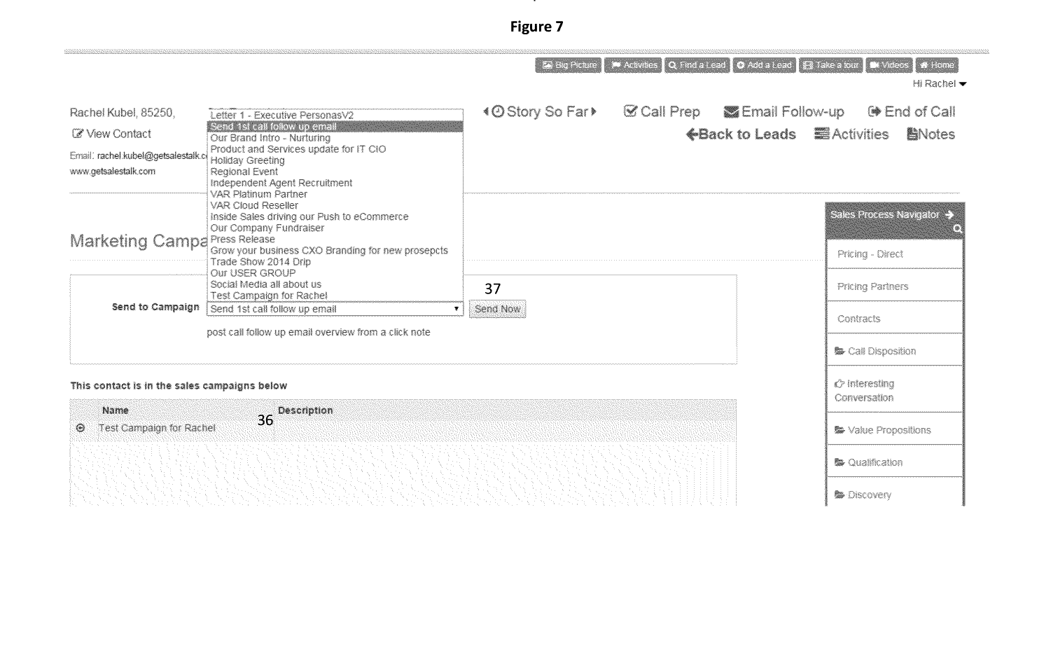

Referring now to the invention in more detail, in FIG. 7 (Marketing Campaigns), the invention allows a sales rep to control which marketing campaign(s) a prospect should be placed into (or removed from) based on the sales rep's insight into understanding how a prospect should be handled in the nurturing process.

In more detail, still referring to the invention of FIG. 7, a sales rep can remove a prospect from a marketing campaign that does not match where they are in the sales process (36). Prospects can also be added to marketing campaigns that will help facilitate the sales process (37). Sales reps no longer need to rely on their marketing department to manage prospects. Delays in removing a prospect from a campaign may negatively impact the prospect's reaction to communications triggered by a campaign based on the sales rep's interaction with that prospect. Similarly, delays in adding a prospect to a timely and relevant communication may result in a missed opportunity.

1. An integrated system for optimizing sales performance by providing sales representatives and managers of an organization a computer system and information to execute best sales strategies, comprising: a) a cloud-based storage device storing a computer system and an organization's database, including said organization's information database and prospect database, accessible from a sales representative's (sales rep's) electronic device; b) one or more communication devices enabling the sales rep to communicate with a prospect; c) one or more application servers hosting web-enabled applications with which the system synchronizes data, including web-enabled customer relationship management (CRM) systems; d) a memory system having instructions which, when executed, cause the system to perform multiple programs assisting the sales rep with relevant verbal and digital communications with the prospect, and tracking, recording, reporting information throughout the sales cycle for each prospect and sales rep; e) said programs tracking the prospect's digital behavior and adding such behavior to a prospect record; f) said programs enabling a search of the organization's database by the sales rep for relevant talking points; g) said programs sending pre-scripted or personalized emails and other pertinent information to the prospect; h) said programs tracking and timing each activity in a sales process, beginning with a sales rep's call preparation and all subsequent activities between the sales rep and prospect and adding such activity to the prospect record; i) said programs aggregating all prospect behavior and sales rep activities and creating a story-so-far; j) said programs filtering views of such story-so-far based on criteria selected by the sales rep or a sales manager; k) said programs accumulating and summarizing analytical data for each prospect and sales rep's activities from the initiation of contact to close of sale; l) said programs graphically displaying said analytical data for sales managers enabling them to monitor, analyze and improve their sales processes.

2. The system as claimed in claim 1, said programs further comprising:
synchronizing the story-so-far activities captured in the prospect record with the user organization's CRM system.

3. The method of claim 2, wherein the system adds incremental value to the organization's CRM system by having the chronological story-so-far activities automatically included in such CRM system and eliminating the need for sales reps to manually update such CRM system.

4. The method of claim 1, wherein further comprising the step of inputting an unlimited number of talking points that represent the organization's marketing materials, product details, pricing data, competitor information, sales strategies and processes, best practices, and other relevant sales information, utilizing cut-and-paste tools or keying information directly into one or more cloud-based servers and creating the organization's information database of such talking points accessible to said programs.

5. The method of claim 4, wherein said talking points are immediately indexed creating fast and flexible keyword searches of all said talking points.

6. The method of claim 4, wherein the sales rep can query the talking points with a key-word search to find relevant talking points and said talking points are displayed on the sales rep's electronic devices.

7. The method of claim 1, wherein sales rep can query the organization's information database with a key-word search to find relevant talking points and said talking points are displayed on sales rep's electronic devices.

8. The method of claim 1, wherein further comprising the step of creating any number of contextually relevant navigators that best represent the optimal way for sales reps to navigate through the organization's information database.

9. The method of claim 8, wherein the system displays on each display screen page a moving navigator drop-down list displaying a representation of subject matter topics to assist the sales rep in finding relevant, representative talking points.

10. The method of claim 1, wherein further comprising the step of mapping the organization's prospect database into one or more cloud-based servers and making the organization's prospect database accessible to said programs.

11. The method of claim 1, wherein sales rep can send scripted or personalized emails, add or remove prospects from existing campaigns, and create one-to-one customized sales campaigns for prospects.

12. The method of claim 1, wherein the system produces various reports analyzing and graphically displaying the sales activities by prospect and by sales rep enabling the sales manager to monitor, analyze and improve sales strategies based on being able to identify the most effective activities for closing deals faster.

13. A computerized system for capturing and depicting a complete timeline of all prospect digital behaviors and sales rep activities in a story-so-far, said method comprising: tracking the prospect's digital behavior and aggregating said digital behavior in the prospect's record; tracking, timing and capturing a sales rep's activities relating to a prospect, including verbal and electronic communications, talking points and emails; updating the prospect's record with said activities; providing drop-down filters enabling sales reps and sales managers to view said story-so-far in its entirety or through different selection criteria.

14. The method of claim 13, wherein said story-so-far captures the complete timeline of activities for each prospect and provides sales reps and sales managers drop-down filters to view activities according to any selection criteria.

15. The method of claim 13, wherein recording all activities undertaken by the sales rep, said method comprising: capturing and timing the sales rep's time spent in call preparation, discussing specific talking points, preparing emails, creating one-to-one campaigns, all designed for the purpose of providing detailed insight into prospect's specific interests and inquiries, tracking sales rep's sales activities, and memorializing such prospect and sales rep activities and time in the story-so-far.

16. The method of claim 13, said programs further comprising the step of tracking frequency and length of time each talking point is used by the sales rep, and displaying graphical charts and reports for sales managers to monitor, analyze and improve the effectiveness of talking points, update sales processes to promote use of talking points most often used by the most successful sales reps; and allowing sales managers to monitor adherence of sales reps to the organization's sales processes.
